(19) United States
(12) Patent Application Publication
(10) Pub. No.: US 2008/0160133 A1
(43) Pub. Date: Jul. 3, 2008

(54) Low Fat, Whey-Based Cream Cheese Product With Carbohydrate-Based Texturizing System and Methods of Manufacture

(75) Inventors: Tamara Vaughn Brooks, Chicago, IL (US); Alice Shen Cha, Northbrook, IL (US); Isabelle Marie-Francoise Laye, Wheeling, IL (US); Andrew Edward McPherson, Mt. Prospect, IL (US); Ellen Y. Zhao, Arlington Heights, IL (US)

Correspondence Address: FITCH EVEN TABIN & FLANNERY, 120 S. LASALLE STREET, SUITE 1600, CHICAGO, IL, 60603-3406, US

(73) Assignee: KRAFT FOOD HOLDINGS, INC., Northfield, IL (US)

(21) Appl. No.: 11/940,778

(22) Filed: Nov. 15, 2007

Related U.S. Application Data
(60) Provisional application No. 60/882,036, filed on Dec. 27, 2006.

(51) Int. Cl. A23C 19/076; A23C 9/12

(52) U.S. Cl. 426/36; 426/582

(57) ABSTRACT

A whey-based cream cheese food product is disclosed that comprises at least about 60% moisture, less than about 20% fat, less than about 20% protein, wherein the protein component is made up of at least 50% whey protein, and about 0.4 to about 15% of a carbohydrate-based texturizing composition, and methods of manufacture thereof, to provide a food product with a creamy and firm texture comparable to a full fat conventional casein-based cream cheese food product. The carbohydrate-based texturizing composition is made up of about 37 to about 96% low dextrose equivalent maltodextrin or oligofructose, about 1 to about 50% of at least one gum, and optionally about 0.1 to about 19% starch blend. The method of manufacture may include either a fermentation process or a one-day acidification process.

### FIELD

This invention generally relates to a low fat, whey-based cream cheese product with a texturizing system, and more specifically to a whey-based cream cheese product with a carbohydrate-based texturizing system to provide a low-fat food product with a creamy and firm texture.

### BACKGROUND

There are many non-fat, reduced fat and low fat cream cheese and dairy products known in the art. These cream cheese and dairy products typically are generally made from a casein-based or casein-dominated protein system. Casein is the dominant protein found in milk and cheese products, and is an expensive raw material.

One example of such a casein-dominated protein dairy product is described in U.S. Pat. No. 5,676,984. This involves a method for making a cultured fat-free cream cheese that consists of using casein-dominated protein and conventional processing methods involving fermentation and three heating steps prior to a homogenization step at the end. During the first heating step, dry ingredients may be added that include bulking agents (such as whey protein and maltodextrin) and stabilizing hydrocolloids (such as modified food starch and gum). During the second heating step, stabilizing hydrocolloids can be added, such as xanthan gum. This process involves using the expensive casein-based starting materials and involves many process steps. The overall process is expensive and time-consuming.

Similarly other casein-dominated cream cheese products are disclosed that utilize similar ingredients. U.S. Pat. No. 6,689,402 provides a process for making a fat-free cream cheese-like fermentation product. A milk composition is inoculated with a culture and fermented, and then at least one bulking agent is added, such as corn syrup and/or modified starch. The mixture is heated and a vegetable gum is then added. U.S. Pat. No. 5,079,024 discloses a non-fat cream cheese product made with a casein-dominated protein system. The process begins with a source of concentrated skim milk that is fermented with a lactic starter culture and then mixed. During a second mixing step, gum is added and then the mixture is homogenized. During a third mixing step, gum and a bulking agent, such as corn syrup, are added. The mixture is then homogenized again to provide the final product. This involves a complex process which requires multiple heating, agitation, and homogenization steps. Still another casein-dominated protein system is provided in U.S. Pat. No. 5,180,604, which discloses a non-fat cream cheese product that does not contain starch or maltodextrin, but uses a gum as part of a stabilizer system. As mentioned above, these methods and products utilize the expensive casein-based starting materials, and often require complex manufacturing processes.

Whereas casein and caseinates are in high demand and high in cost, whey proteins are relatively low-cost, and are often even discarded as a byproduct of the cheese making process. This underutilization of whey protein has led to increased focus on methods of manufacturing cheese products using concentrated whey protein or whey protein isolates. For instance, U.S. Pat. No. 6,419,975 discloses a method for making caseinless cream cheese-like products that use non-casein proteins such as whey protein. In addition to the aforementioned advantages of incorporating whey protein into food products, this process also has an advantage in that it does not require a coagulation or fermentation step, since the process begins with whey protein rather than the formation of a curd from milk. Therefore, the process may be carried out in a much shorter time frame. Other methods mentioned in the patent also focus on the use of other non-casein proteins, such as soy or other vegetable proteins, for making cheese-like products, and may optionally include the addition of stabilizers such as gums. However, the caseinless cream cheese-like products utilizing whey protein generally do not yield a texture similar to that found in cream cheese products from conventional processing of casein-based products.

An additional benefit of incorporating significant amounts of whey proteins into food products is that they have high nutritive value for humans. In fact, the amino acid composition of whey proteins is close to an ideal profile for human nutrition. Whey proteins are also understood to have superior emulsifying capabilities in comparison with casein. Without wishing to be bound by theory, the incorporation of whey protein is expected to reduce defects such as phase separation during processing. In addition, such whey proteins provide a low cost dairy product which, if successfully incorporated into cheese products, would significantly increase the overall efficiency and effectiveness of the cheese making process.

U.S. Pat. No. 6,322,841 discloses cheese-like dairy gels that include a gum, a starch, preferably a modified starch, and a dairy liquid (a milk substance). Whey is disclosed as a by-product of the dairy liquid, where the method tries to use essentially all the components from the liquid milk product made during processing. However, whey proteins may also be included as an additive to the milk and/or casein. Maltodextrin is also disclosed but is identified as having an insignificant contribution to the firmness characteristics desired of the cheese gel. The process steps involved to make the cream cheese are different from the known methods; this method avoids curding, clotting, setting by a rennet, acid, or a culture. Rather, the process steps disclosed involve blending, heating, and cooling. This dairy gel may require fewer processing steps, however it still utilizes a large amount of casein-based material and requires formation of a curd from milk instead of beginning with a whey protein as a raw material. Furthermore, it provides a cheese-like product having a gelled form, texture, consistency and mouthfeel of cheese, not cream cheese.

Other non-cream cheese products may be made with whey addition, such as a margarine spread, as discussed in U.S. Pat. No. 5,679,395. The patent discloses using a thickening agent, comprising starch and a starch-based texturizing agent, instead of traditional thickening agents like hydrocolloids, to prepare fat-free, reduced fat and low fat margarine-like spreads and cream cheese. The non-fat margarine-like spreads can be made without milk or with non-fat dairy ingredients, like skim milk or milk protein isolates, such as whey protein isolates, however, examples of what amounts of whey protein isolates can be used with the margarine spreads is not given. The thickening agent comprises starch and a starch-based texturizing agent, where the starch may comprise maltodextrin or a modified starch and the starch-based texturizing agent comprises an amylase starch. No additional gelling agents are required, and no emulsifiers or gums are required; however, gums can be incorporated to modify (i.e., soften) texture. A cream cheese may similarly be made with the same thickening agent by adding starch and a starch-based texturizing agent to a dairy ingredient; however, the addition of whey is not disclosed for cream cheese. For the manufacture of a non-fat, reduced, or low fat cream cheese, typical dairy ingredients are added along with a starch based texturizing agent contains from 1% to 6% by weight (e.g., amylase containing barley, pea, or corn starches) and about 5% to about 15% maltodextrin. The contents are mixed, homogenized, and then pasteurized. The cream cheese is made with casein-based starting materials, thus adding to the expense of the process. The patent refers to other processes that involve a mixture of starch, gelatin, emulsifiers and gum as being complex mixtures and involving complex processing with poor spreadability and chalky mouthfeel.

Under the current U.S. Standards of Identity, cream cheese is required to contain at least 33 percent fat and no more than 55 percent moisture. Lower fat cream cheeses usually contain correspondingly higher proportions of moisture due to the decreased fat content. For instance, USDA specifications for light and reduced fat cream cheese allow up to 70 percent moisture. Light cream cheese can be defined as less than 16.5% fat and low fat cream cheese can be defined as less than 6% fat. However, increased moisture levels in the cream cheese will often result in cream cheese products that are too soft and do not have the desired firmness of normal, higher fat cream cheeses. Therefore, gums traditionally have been added to low fat cream cheese in order to impart a firmer texture. Unfortunately, the addition of gums and the like also results in a more gel-like texture that is less desirable than the smooth, creamy texture of normal cream cheese, and does not spread as well as normal cream cheese.

Therefore, there remains a need for a low fat, high moisture cream cheese or cream cheese-like product that has a firm and spreadable texture similar to normal cream cheese and a decreased deformation (decreased gel-like texture) when compared to conventional low fat, high moisture cream cheese. There also remains a need for a low fat, high moisture, low casein cream cheese or cream cheese like product that has a firm and spreadable texture similar to normal cream cheese and has a decreased deformation when compared to conventional low fat, high moisture, low casein cream cheese. Conventional experience has indicated that reducing the level of casein in cream cheese formulations makes it much more difficult to achieve and maintain a desirable finished texture of the food product, such as in terms of firmness, smoothness, spreadability, and the like. Therefore, it would be desirable to provide a continuous process for making cream cheese products, particularly high moisture low fat content cream cheese products using low casein or casein-free cream cheese formulations and mixes, that still achieves and maintains acceptable texture and sensory attributes. It is also desirable to provide a low-fat cream cheese with lower casein content and higher whey protein content that has texture and spread attributes similar or identical to traditional, higher fat cream cheese.

### SUMMARY

A whey-based cream cheese food product is disclosed that comprises at least about 60% moisture, less than about 20% fat, less than about 20% protein, and about 0.4% to about 15% of a carbohydrate-based texturizing composition, to provide a food product with a creamy and firm texture comparable to a conventional casein-based cream cheese food product. The protein is made up of at least about 50% whey protein, and in particular at least about 80% whey protein. The whey protein source may be provided by a whey protein concentrate (WPC), a whey protein isolate (WPI), a sweet whey, acid whey or any combination thereof.

The total fat may preferably be provided in the range from about 0.5 to about 20% (more preferably from about 1.5 to about 18%), the total protein may preferably be provided in the range of from about 5 to about 20%, and the total moisture level may preferably be provided in the range of about 60 to about 80%. The fat source may be a dairy fat, a vegetable fat, or animal fat, or any combinations thereof. The moisture may consist of water, milk, or cream, or any combinations thereof. The mixture may further optionally include an emulsifier, such as diglycerides, monoglycerides, distilled monoglycerides, lactic acid monoglyceride, glycerol monostearate, sodium stearoyl lactylates, and mixtures thereof. If used, the emulsifiers are generally present in amounts from about 0.01 to about 0.5%.

The carbohydrate-based texturizing composition comprises a low dextrose equivalent maltodextrin or oligofructose, a gum or a gum blend, and optionally a starch blend. The carbohydrate-based texturizing composition further comprises about 37% to about 96% of low dextrose equivalent maltodextrin or oligofructose, about 1% to about 50% of the gum or the gum blend, and optionally 0% to about 19% starch blend.

A method of manufacture for a whey-based cream cheese product is also provided where the whey protein source is mixed with water and a fat source to provide a first mixture, using a one-day direct acidification process. This first mixture is then heated and optionally homogenized in a first homogenization step. Dry ingredients are blended together to form the carbohydrate-based texturizing composition comprising low dextrose equivalent maltodextrin or oligofructose and a gum or gum blend. The texturizing composition may further contain a starch blend. Although, not part of the texturizing system, other ingredients (e.g., acid, salt and the like) may be incorporated into the product via the texturizing system. The texturizing mixture is then added to the first mixture and heated. Although, preferred to be added as a preblended or prepared composition, the individual components of the texturizer system may be added separately. The mixture may again optionally be homogenized in a second homogenization step. The overall process, however, must contain at least one homogenization step, where at least either the first or the second homogenization step is incorporated. This method of manufacture of the whey-based cream cheese generally can be completed within about 24 hours, without the need for an additional fermentation step.

An alternative method of manufacture may comprise a two-day cultured fermentation process that includes a pasteurization step after mixing the ingredients together to create the first mixture and an optional first homogenization step, followed by adding a culture to the first mixture and allowing it to ferment for at least about 10 hours and/or further adding an acid. After at least about 10 hours, the dry ingredients are added together to make the carbohydrate-based texturizing composition, which is then added to the first mixture and heated. This is followed by an optional second homogenization step. Again, however, the overall process must contain at least one homogenization step, where at least either the first or the second homogenization step is incorporated.

### BRIEF DESCRIPTION OF THE DRAWINGS

FIG. 1 provides a schematic flow diagram for one example of a method of making a whey-based cream cheese product using a one-day direct acidification process; and

FIG. 2 provides a schematic flow diagram for one example of a method of making a whey-based cream cheese product using a two-day cultured fermentation process.

### DETAILED DESCRIPTION

Whey-based cream cheese products are provided containing high moisture, low to no fat content, and having a texture and spreadability similar to cream cheese having higher fat and lower moisture content. The desired texture may be achieved in whey-based cream cheese-like spreads with even higher moisture content than those presently commercially available through the addition of a carbohydrate-based texturizing composition. The low casein or casein-free cream cheese products having improved texture and spreadability are made with substantial levels of non-casein proteins (i.e., whey proteins), such as at least 50% of the total protein, and with higher than normal moisture content, such as greater than about 60%, and particularly about 65 to about 80% moisture by weight, and lower fat such as less than about 20 percent, and particularly about 0.5 to about 20% fat by weight (and preferably about 1.5% to about 18%). The whey-based cream cheese product surprisingly mimics characteristics of a cream cheese product prepared using casein protein. Thus, a high moisture, low fat, low casein cream cheese system that despite its high moisture low fat composition having similar texture attributes as common commercial light cream cheese with lower moisture, higher fat, and higher casein content (e.g., a typical light cream cheese with at least about 85% casein and about 15% whey in the total protein make-up, moisture content of about 55-70%, and fat content of about 16.5%) is provided.

In contrast to prior art cream cheese products with substantial amounts of non-casein protein (i.e., whey proteins), the whey-based cream cheese-like products of this invention with substantial amounts of whey protein with the carbohydrate-based texturizing composition yield a cream cheese product with a desirable firmness akin to that of normal casein-based cream cheese that is smooth and highly spreadable. Moreover, the gel-like texture of prior art cream cheese-like products made with substantial amounts of non-casein proteins is avoided. Qualitative measurements indicate firmer, smoother, and more spreadable texture can be achieved.

The whey-based low to no fat cream cheese product may be made by combining less than about 20% of a protein source with at least about 60% moisture, comprising water and/or a dairy source, such as milk, with less than about 20% of a source of fat and with about 0.4% to about 15% of a carbohydrate-based texturizing composition. The protein source comprises less than about 20% of the cream cheese mixture, and particularly from about 5 to about 20%. The protein source further comprises at least about 50% whey protein source, and in particular at least about 80%, with the remaining amount, if needed, being made up of a casein-based protein source. The whey protein source may be selected from one or more of whey protein concentrate, whey protein isolate, sweet whey, and acid whey. The moisture source comprises at least about 60%, and in particular about 65 to about 80%. The moisture comprises water, milk, cream or combinations thereof.

Less than about 20% of a fat source is also added to the mixture, and in particular from about 0.5 to about 20%, and even more in particular from about 1.5 to about 18%. The fat source may be a dairy fat, a vegetable fat or an animal fat. Examples of dairy fats may include milk, skim milk, cream, butter, anhydrous milk fat, fatted whey protein concentrate and any combination thereof. Examples of vegetable fats may be an oil such as soybean, palm kernel, canola, corn, coconut, and any combination thereof. Examples of animal fats may include lard, tallow, and chicken fat. Dairy sources of fat are preferred such as milk and/or cream.

The carbohydrate-based texturizing composition includes low dextrose equivalent maltodextrin or oligofructose, a gum or a gum blend, and optionally a starch blend, at about 0.4 to about 15% of the total cream cheese product. The carbohydrate-based texturizing composition may comprise about 37 to about 96% low dextrose equivalent maltodextrin or oligofructose (about 0.2 to about 12% of the total cream cheese product). Oligofructose is a polysaccharide consisting of a linear chain of fructose units that may terminate in a glucose unit. More specifically, oligofructose is a soluble dietary fiber. Preferably, a maltodextrin is used, with potato maltodextrin being the most preferred. Alternately, low dextrose equivalent maltodextrins from other starch sources (e.g., corn, tapioca, wheat) may be used; but since they are generally less effective, they must be used at higher formula levels. The carbohydrate-based texturizing composition may further comprise about 1 to about 50% of gum or gum blend (about 0.1 to about 1.0% of the total cream cheese product). The gum or gum blend may contain one or more of the following gums: xanthan gum, guar gum, Tara gum, locust bean gum, carrageenan gum, alginate gum, pectin gum, Konjac gum, carboxymethylcellulose gum, methylcellulose gum, and hydroxyl propyl methylcellulose gum. Where the gum blend comprises mixing together two gums, both gums chosen will be different from each other and the first gum will be added at a level from about 0.2 to about 0.8%, and the second gum will be added at a level from about 0.01 to about 0.6%. Alternatively, the two gum blend may comprise a first gum and a second gum in a ratio of about 10:90 to about 90:10, and at least one gum may be either ionic or nonionic. For example, if a two gum blend is used, both gums may be ionic, or both may be nonionic, or still one gum may be ionic while the other gum is nonionic. Preferred ionic gums may comprise xanthan, carrageenan, alginate, pectin, carboxymethylcellulose, methylcellulose, and hydroxyl propyl methylcellulose. Preferred nonionic gums may comprise guar, Tara, locust bean, and Konjac. In some cases, an additional gum or gums may be added to the gum blend.

The carbohydrate-based texturizing composition still further may comprise 0 to about 19% starch blend (0 to about 2.0% of the total cream cheese product), and in particular a modified starch blend. The starch blend may comprise a blend of acid thinned or “thin boiling” starches (i.e., such as the commercially available starch, FLOJEL, National Starch Co., Bridgewater, N.J.). Thin boiling starches are commonly used in the confection industry to provide high-solid and strong gels in candies. Optionally the starch blend can contain dual modified starch (cross-linked and propylated), such as cook-up starch from corn, potato, tapioca or wheat; these appear to be useful for imparting in-process viscosity and may also assist in syneresis control over shelf-life of the product. Starches such as Thermflo (National Starch, Bridewater, N.J.), or Farinex VA-40, (Avebe, Holland) are effective examples. The amounts of the starch blend in the overall cream cheese composition may be from 0 to about 2.0%. The whey-based cream cheese product may further comprise addition of an emulsifier. Examples of emulsifiers may comprise at least one of diglycerides, monoglycerides, distilled monoglycerides, lactic acid monoglyceride, glycerol monostearate, sodium stearoyl lactylates (e.g., trade name-Emplex), and at amounts of up to about 0.5% of the total cream cheese composition.

Regular, casein-based cream cheese typically has a hot viscosity of about 50 to about 80 Pascal at about 165° F. The whey-based cream cheese product of the invention may have a hot viscosity of at least about 10 Pascal, and in particular from about 20 to about 80 Pascal at this same temperature. In addition, the whey-based cream cheese product may have a Haake cold yield stress or cold viscosity above about 1000 Pascal, more preferably above about 1500 Pascal, when yield stress is measured using a commercially available instrument such as a Haake Viscotester VT550 at approximately 45° F. (i.e., refrigeration temperature).

Without wishing to be bound by theory, the carbohydrate-based texturizing system appears to absorb more whey into the product, such that larger amounts of whey may be used than previously possible and while still obtaining the desired firm texture properties and creamy mouthfeel of a casein-dominated cream cheese product. The carbohydrate-based texturizing composition helps to shift the predominant protein from casein protein to whey protein.

The whey-based cream cheese product is especially suitable for producing cream cheeses with a low casein amount (0 to about 50%) and a high whey amount (about 50 to about 100%). Preferably at least about 80% of the total protein is whey protein. A number of processes may be used to form spreadable cream cheese product of this invention (e.g., two-day cultured fermentation process or a one-day acidification process).

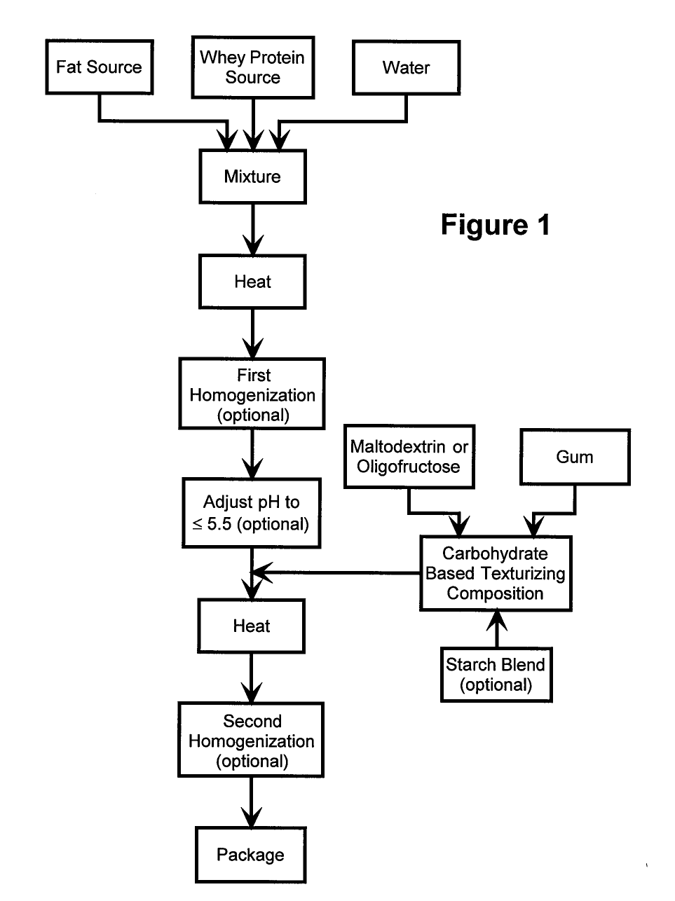

A one-day direct acidification process is disclosed and is illustrated in FIG. 1. The low fat, high moisture cream cheese is produced from water, a whey protein source (for example, whey protein concentrate, whey protein isolate, sweet whey, acid whey, or combinations thereof) and a source of fat (for example, cream, butter, anhydrous milk fat, vegetable fat, or combinations thereof). The whey protein source can be supplied in dry or liquid form. The whey protein source preferably is comprised of at least about 50 to about 100% whey protein, particularly at least about 80% on a dry basis, of the total protein makeup.

For example, the fat source, such as anhydrous milk fat, concentrated milk fat (cream), butter, or other dairy fat may be added to a whey protein source. Optionally, an edible vegetable oil may be used as the fat source instead of a dairy fat. Suitable vegetable oils in this respect include, for example, palm oil, palm kernel oil, canola oil, hydrogenated soybean oil, and the like, as well as mixtures thereof. Still optionally, an animal fat may be used as the fat source. The fat may be added directly to, and blended with, the whey protein source to form a protein-fat mixture, or cream cheese mix. A pH adjustment step may optionally be performed if needed to adjust the pH to a desired range, in which the pH of the cream cheese mix is adjusted to a “normal” range desirable in the finished product of about 5.5 or lower, or preferably about 4.2 to about 5.3. Alternatively, the optional pH adjustment step may be performed prior to the addition of cream to form a cream cheese mix, or after the steps that follow. Optionally, other protein sources, including without limitation dry whey powder, whey protein concentrate, milk protein concentrate, fresh milk, and non-fat dry milk can be added along with the fat source.

This optional pH adjustment may be performed in order to ensure that the desired range is targeted so that the finished product does not have an acidic or sour flavor. Without the pH in the desired range, the finished product would still have a desirable texture, with increased firmness and spreadability, but may have undesirable off flavors. However, it is contemplated that one of skill in the art may manipulate this pH adjustment in order to impart particular flavors on the finished product. Furthermore, the pH level may also be important for microbial reasons, since pH levels that are too high (i.e., greater than 5.5) may be more susceptible to microbial growth.

Alternatively, an acidified whey protein aggregate may be used and stored under refrigeration for one week or more prior to blending with cream to form a cream cheese mix. In this case, the whey protein source may be treated with one or more food grade organic or mineral acids. The food grade acid is an edible acid selected from the group consisting of citric acid, acetic acid, lactic acid, malic acid, fumaric acid, tartaric acid, hydrochloric acid, sulfuric acid, and phosphoric acid, or a combination thereof. This acidification treatment of the whey protein generally may be conducted in an aqueous medium. The pH of the whey protein aggregate may be lowered to a level at or below about 5.5. Acidified whey protein aggregate is then further processed to form a low casein cream cheese-like product.

The cream cheese mix or protein-fat mixture may then be subjected to a first heating step and then optionally a first homogenization step. Preferably, this first homogenization step may be carried out at 2000/500 to 5000/500 psi at or near the melting point of the fat source (for instance, at about 120° F.). This example refers to a two-stage homogenization treatment with 2000-5000 psi applied in the first stage and 500 psi in the second stage. Alternatively, a one-stage homogenization step at about 2000 psi to about 5000 psi may be used. Then the carbohydrate-based texturizing composition is preblended, and comprises at least a low dextrose equivalent maltodextrin or oligofructose and a gum. Optionally, a starch blend may be added. The carbohydrate-based texturizing composition is then added to the cream cheese mix and the mixture may then be subjected to a second heating step, preferably at about 175 to 200° F. for about 5-30 minutes. The mixture may also optionally be blended with emulsifiers and/or emulsifier salts, gums, and other common additives. Finally, the mixture may be homogenized again in a second homogenization step, preferably at 1000/500 to 5000/500 psi. Once again, a one-stage homogenization step may alternatively be used. The first and second homogenization steps noted above are considered optional; nonetheless, at least one of the first or second homogenization steps should be included in the process. Thus, if one is omitted, the other should be included. Generally, for cream cheese products containing 1% or more overall fat, preferably at least the first homogenization step is used; the use of the first homogenization step (i.e., prior to addition of the texturizing system) aids in distributing the fat throughout the product. For cream cheese products containing less than 1% overall fat, preferably at least the second homogenization step is used; the use of the second homogenization step (i.e., after addition of the texturizing system) helps to further mix the product. Of course, both the first and second homogenization steps may be included if desired.

The resultant cream cheese product may be packaged by any number of methods, including hot fill processes. Once cooled, the cream cheese has a firm, smooth, and spreadable texture, with a pleasant, mild dairy flavor. Natural dairy flavors or other flavors may optionally be added. Optionally, other additives such as calcium, vitamins, or other additives may be added, preferably before homogenization.

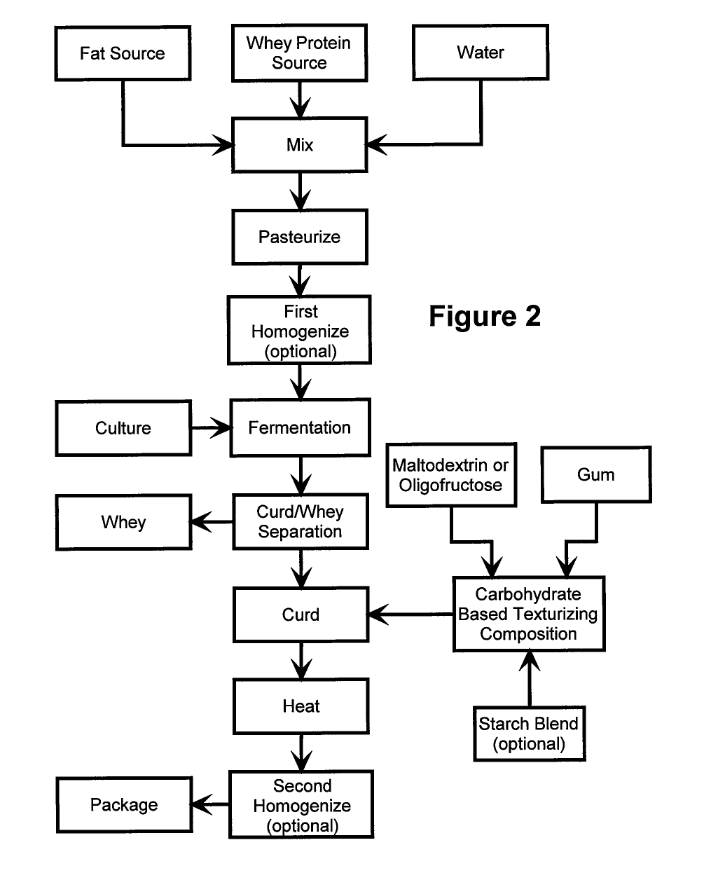

Alternatively, a two-day fermentation process may be employed, as illustrated in FIG. 2. After the whey, fat source and water are combined and mixed, a pasteurization step may take place. After the pasteurization step, the cream cheese mix may then be homogenized in an optional first homogenization step similar to that used for the one-day acidification process. The cream cheese mix may be cooled and a culture added; the fermentation step takes place for at least about 10 hours. The time period for fermentation is more or less determined by the desired pH; the fermentation period should last as long or as short as is necessary to reach the target pH value, for example an acceptable value of about 4.8 pH. Suitable cultures may comprise a lactic starter culture, selected from among mesophilic and thermophilic lactic acid producing bacteria. After at least about 10 hours, the preblended carbohydrate-based texturizing composition is added and mixed while heating the cream cheese mix. Finally, the mixture may be homogenized again in a second optional homogenization step, similar to the acidification process parameters. The overall process will comprise at least one homogenization step, and whether it is at least the first or the second step depends upon the desired texture and consistency of the product at the time of the homogenization. The product may then be packaged. Typically, the two-day fermentation process yields a final product that is preferable to consumers because of its “culture notes.” Culture notes refer to the flavor or aroma that is associated with a fermented cream cheese product, a flavor or aroma that is not as prominent in a one-day acidification process.

Still alternatively, a curd-whey cream cheese process may also be employed utilizing the curd from the process as the cream cheese portion. After the whey, fat source and water are combined and mixed, a pasteurization step may similarly take place. After the pasteurization step, the cream cheese mix may also be homogenized in a first homogenization step similar to the range used for the above-mentioned processes. After the homogenization step the cream cheese mix can also undergo an optional acidification step, which may comprise either a direct acidification (i.e., a pH adjustment) or adding a culture, if a two-day fermentation process is utilized. This pH adjustment step can be optional if an acid whey ingredient is used, for example, which is already acidified. After the fermentation process, and before or after the pH adjustment if used, a separation step is employed to remove moisture from the curd portion. The separation step may comprise either a centrifugation process, where part of the whey can also be removed, or an ultrafiltration process, where the whey remains with the curd. After the separation step, the preblended carbohydrate-based texturizing composition is added to the curd portion and mixed while heating the mixture. Finally, the mixture may be homogenized again in a second homogenization step, similar to the above-mentioned process parameters. The overall process will comprise at least one homogenization step. The product may then be packaged.

Referring to FIG. 1, a flow chart is shown depicting one possible method for making a high moisture, low casein, and low fat cream cheese. The first step shows addition of at least a whey protein source combined with a fat source and water to form a first mixture that is mixed and then followed by a heating step. The first mixture may then be subjected to a first homogenization step, which can be optional, however there should be at least one homogenization step overall. The next step comprises an acid adjustment, which can comprise a direct acidification process (i.e., utilizing a pH adjustment), to bring the pH to a required range, such as a pH of about less than 5.5. The next step involves the addition of the carbohydrate-based texturizing composition, which is preblended to first combine the maltodextrin or oligofructose, gum blend and optionally starch blend, mixed together separately and then added to the first mixture. The combined mixture is then heated and subjected to a second homogenization step, which may be optional as long as the first step was carried out. After the optional second homogenization step, the whey-based cream cheese product is packaged, such as by a hot-fill process.

Referring to FIG. 2, an alternate method is depicted. This alternate method can include similar steps as in FIG. 1 up to the first homogenization step, if used. Similarly, this step can also be followed by a pH adjustment step; in FIG. 2 the pH adjustment is done by addition of a culture to carry out the fermentation process, which is typically between 12-18 hours. After the fermentation step a separation step is employed to separate at least the curd from the moisture. The carbohydrate-based texturizing composition is then added to this curd mixture and the remaining steps are similar to those employed in FIG. 1 following the texturizing composition addition. The moisture that is separated out may be discarded or reused for another process.

The whey-based cream cheese products have surprisingly firm texture and spreadability for products with such low amounts of casein, high amounts of moisture, and low amounts of fat. Sensory tests have shown that the whey-based cream cheese product results in firmer textures and better spreadability than otherwise possible in low casein, low fat, high-moisture cream cheese products. Furthermore, tests have shown the whey-based cream cheese compared to a casein-based cream cheese generally is less grainy, less powdery, softer and has a smaller particle size.

The following examples describe and illustrate certain processes and products of the whey-based cream cheese product. These examples are intended to be merely illustrative and not limiting thereof in either scope or spirit. Those skilled in the art will readily understand that variations of the materials, conditions, and processes described in these examples can be used. Unless otherwise noted, all percentages and ratios are by weight. All publications included in the present specification, including patents, patent applications, patent publications, and general literature references, are hereby incorporated by reference.

### EXAMPLE 1

A whey-based cream cheese product containing about 1.8% fat was made by mixing 160.54 grams of WPC-53 (whey protein concentrate, FDA 50, First District Association, Litchfield, Minn.) with 1416.19 grams of UF acid whey slurry by lightening mixer to make a wet mix. Added to the mix was 3.63 grams of an emulsifier, such as Emplex-K (Caravan Ingredients, Kansas City, Mo.), which was added into the wet mix using a turbomixer to make a coarse emulsion. The wet mix was then heated in a Stephan Cooker at 140° F. for about 15 minutes. The cream cheese slurry was then homogenized in a two-stage homogenizer at 5000/500 psi. Dry ingredients were then preblended to form the carbohydrate-based texturizer system (see Table 1-2) comprising 145.12 grams of C-delight MD 01970 (a spray-dried maltodextrin, Cargill, Hammond, Ind.), 59.68 grams of maltodextrin DE-10 (MD-DE10, Tate & Lyle Food Ingredients, Decatur, Ill.), 7.26 grams of Carob gum (also called locust bean gum), 1.81 grams xanthan gum, 16.33 grams salt. The dry blend, at about 12.69%, was then added slowly into the cooker along with the additional ingredients of 0.91 grams of sorbic acid and 2.18 grams citric acid. The homogenized mixture was heated at 200° F. for 15 minutes. The addition of 0.36 grams of a flavor was made. The temperature and the moisture were checked and then corrected to the target moisture by adding the flavor component. The sample was homogenized using a two-stage homogenizer at 3000 psi/500 psi and then packaged via hot-filling into 8 oz. tubs. Table 1-1 below shows the whey-based cream cheese product makeup. The whey-based cream cheese product was made to target about 70% moisture, about 1.81% fat, about 8.16% protein, and about 8.59% lactose. The resulting sample had a texture and consistency comparable to a full fat cream cheese sample having substantially more casein protein than whey protein.

TABLE 1-1
Example 1 Sample Makeup

| Ingredient | % |
|---|---|
| UF Acid Whey | 78.07 |
| WPC-53 | 8.85 |
| Emplex-K | 0.20 |
| Texturizer System | 12.69 |
| Sorbic Acid | 0.05 |
| Citric Acid | 0.12 |
| Flavor | 0.02 |

TABLE 1-2
Texturizer System Makeup

| Ingredient | % |
|---|---|
| MD-DE10 | 25.93 |
| C-Delight MD 01970 | 63.04 |
| Xanthan Gum | 0.79 |
| Carob Gum | 3.15 |
| Salt | 7.09 |

### EXAMPLE 2

Another sample formulation was used for the makeup of a whey-based cream cheese product containing about 0.80% fat, comprising 390 grams of skim milk, 379.3 grams of water and 196.4 grams of WPC-53 mixed using a lightening mixer. Approximately, seven drops of defoamer, or about 1.5 grams, was added into the slurry (e.g., Defoamer Trans 220K, Trans-Chemco, Inc., Bristol, Wis.). Then lactic acid was added into the mixture until the pH reached about 5.0 (approximately 8 grams was added). The mixture was then heated in a microwave oven to 140° F., in a first heating step. Then 13.5 total grams of the texturizer system (see Table 2-2) comprising salt, gum blends of carob, xanthan, and carrageenan, and maltodextrin (C-Delight MD 01970) were added into the mix. The remaining ingredients comprising 9.1 grams tricalcium phosphate (i.e., (TCP)), 3.0 grams titanium dioxide, 8.0 grams lactic acid, and 0.5 grams sorbic acid were added. The whole mixture was heated with mixing to 185° F. for about 5 minutes. The heated cream cheese slurry was then homogenized in a two-stage homogenizer at 3000/500 psi. The homogenized sample was hot filled in 8 oz. tubs. Table 2-1 below shows the whey-based cream cheese product makeup. The whey-based cream cheese product was made to target about 75% moisture, about 0.79% fat, about 11.5% protein, and about 8% lactose. The resulting sample had a texture and consistency comparable to a full fat cream cheese sample having substantially more casein protein than whey protein.

TABLE 2-1
Example 2 Sample Makeup

| Ingredient | % |
|---|---|
| Skim Milk | 39.00 |
| Water | 37.93 |
| WPC-53 | 19.64 |
| Defoamer | 0.15 |
| Texturizer System | 1.35 |
| Titanium Dioxide | 0.30 |
| Lactic Acid | 0.80 |
| Sorbic Acid | 0.05 |
| Tricalcium Phosphate | 0.91 |

TABLE 2-2
Texturizer System Makeup

| Ingredient | % |
|---|---|
| Carob Gum | 37.04 |
| Xanthan Gum | 3.70 |
| Carrageenan Gum | 3.70 |
| C-Delight MD 01970 | 37.04 |
| Salt | 18.52 |

### EXAMPLE 3

A whey-based cream cheese product containing about 1.5% fat was made in the pilot plant using 11.05 pounds (lbs) of WPC-80 (i.e., whey protein concentrate, Leprino Foods Co., Denver, Colo.), and 1.75 lbs of dried sweet whey mixed into 36.08 lbs of water and 40 lbs of skim milk to make a wet mix batch comprising 88.88 lbs total, mixed using a mixer. The mix was then pasteurized and the resulting cream cheese slurry homogenized in a two-stage homogenizer at 3000/500 psi. The mix was then cooled to 72° F. and a culture consisting of a lactic starter culture was added and allowed to ferment for about 15 hours. A dry blend mixture was pre-blended containing 5.19 lbs of C-delight MD 01970 (i.e., maltodextrin), 0.07 lbs of Flojel 65/Confectioners G (i.e., starch blend), 0.44 lbs of carob gum (i.e., locust bean gum), 0.07 lbs xanthan gum, 0.04 lbs of carrageenan gum, and 0.61 lbs salt to makeup the texturizer system, see Table 3-2. This makeup utilizes a gum blend containing three gums; carob, xanthan, and carrageenan. The mix was heated to 190° F. and 9.17% of the dry blend mixture was added slowly into the mixer with the additional ingredients of 0.04 lbs of sorbic acid, 1.01 lbs of tricalcium phosphate, and 0.21 lbs of titanium dioxide along with 0.08 lbs of flavor and 0.01 lbs of vitamin A. The mixture was then homogenized in a two-stage homogenizer at 3000 psi/500 psi and packaged by hot-filling into 8 oz. tubs. Table 3-1 below shows the whey-based cream cheese product makeup. The whey-based cream cheese product was made to target about 73% moisture, about 1.5% fat, about 10.5% protein, and about 3.7% lactose. The resulting sample had a texture and consistency comparable to a full fat cream cheese sample having substantially more casein protein than whey protein.

TABLE 3-1
Example 3 Sample Makeup

| | |
|---|---|
| Ingredient | % |

Day 1

| | |
|---|---|
| WPC-80 | 11.05 |
| Dried Sweet Whey | 1.75 |
| Water | 36.08 |
| Skim Milk | 40.00 |
| TOTAL Mix/Curd | 89.00 |

Day 2

| | |
|---|---|
| Mix/Curd | 89.00 |
| Texturizer System | 9.17 |
| Sorbic Acid | 0.05 |
| Tricalcium phosphate | 1.44 |
| Titanium Dioxide | 0.30 |
| Flavor | 0.12 |
| Vitamin A | 0.02 |

TABLE 3-2
Texturizer System Makeup

| Ingredient | % |
|---|---|
| Flojel 65/Confectioners G | 1.09 |
| C-Delight MD 01970 | 80.92 |
| Carob Gum | 6.87 |
| Xanthan Gum | 1.09 |
| Carrageenan Gum | 0.54 |
| Salt | 9.49 |

### EXAMPLE 4

A whey-based cream cheese product containing about 1.5% fat was also made in the pilot plant using the same process as example 3, with minor changes to the ingredients. A different whey protein was used, 17.61 pounds (lbs) of WPC-53 (i.e., whey protein) mixed into 36.22 lbs of water and 40 lbs of skim milk to make a wet mix batch comprising 93.83 lbs total, mixed using a mixer. The mix was then pasteurized and the resulting cream cheese slurry homogenized in a two-stage homogenizer at 3000/500 psi. The mix was then cooled to 72° F. and a culture was added and allowed to ferment for about 15 hours. A dry blend mixture was pre-blended containing 1.58 lbs of C-delight MD 01970 (i.e., maltodextrin), 0.14 lbs of Flojel 65/Confectioners G (i.e., starch blend), 0.27 lbs of carob gum (i.e., locust bean gum), 0.08 lbs xanthan gum, 0.18 lbs of CMC-9H4XF (i.e., a particular grade of Sodium Carboxymethyl cellulose, a gum, manufactured by Aqualon, in Wilmington, Del.), and 0.61 lbs salt to form the texturizer system as shown in Table 4-2. This makeup utilizes a gum blend containing three gums, carob, xanthan, and CMC. The mix was heated to 190° F. and 4.07% of the dry blend mixture was added slowly into the mixer with the additional ingredients of 0.04 lbs of sorbic acid, 1.13 lbs of tricalcium phosphate, and 0.21 lbs of titanium dioxide along with 0.08 lbs of flavor and 0.01 lbs of vitamin A. The mixture was then homogenized in a two-stage homogenizer at 3000 psi/500 psi and packaged by hot-filling into 8 oz. tubs. Table 4-1 below shows the whey-based cream cheese product makeup. The whey-based cream cheese product was made to target about 73% moisture, about 1.5% fat, about 10.5% protein, and about 3.7% lactose. The resulting sample had a texture and consistency comparable to a full fat cream cheese sample having substantially more casein protein than whey protein.

TABLE 4-1
Example 4 Sample Makeup

| | |
|---|---|
| Ingredient | % |

Day 1

| | |
|---|---|
| WPC-53 | 17.61 |
| Water | 36.22 |
| Skim Milk | 40.00 |
| TOTAL Mix/Culture | 94.00 |

Day 2

| | |
|---|---|
| Mix/Culture | 94.00 |
| Texturizer System | 4.07 |
| Sorbic Acid | 0.05 |
| Tricalcium phosphate | 1.62 |
| Titanium Dioxide | 0.30 |
| Flavor | 0.12 |
| Vitamin A | 0.02 |
| Total Batch Size | 100 |

TABLE 4-2
Texturizer System Makeup

| Ingredient | % |
|---|---|
| Flojel 65/Confectioners G | 4.91 |
| C-Delight MD 01970 | 55.28 |
| Carob Gum | 9.34 |
| Xanthan Gum | 2.95 |
| CMC - 9H4XF | 6.14 |
| Salt | 21.38 |

### EXAMPLE 5

A whey-based cream cheese product containing about 0.66% fat was made using oligofructose (i.e., inulin) in place of maltodextrin. 35.11% water, 40% skim milk, and 16.67% WPC-53 was combined and mixed in a lightning mixer. Seven drops of a defoamer (i.e., 0.15%), such as Trans-220K, was added to the slurry. Lactic acid was added to the mixture until the pH was about 5.0, which was about 0.70% of lactic acid, and the entire mixture was heated to 140° F. The heated mixture was then homogenized at 3000/500 psi. The following ingredients were then combined: 85.74% oligofructose, (i.e., inulin, manufactured by Orafti Active Food Ingredients, in Malvern, Pa.), a three-gum blend of 7.83% carob gum, 1.74% xanthan gum, and 0.87% carrageenan gum (again utilizing a three-gum blend: carob-xanthan-carrageenan), and 3.83% salt to makeup the texturizer system as shown in Table 5-2. The texturizer system, at about 5.75%, and the remaining ingredients of 1.27% Tricalcium Phosphate, 0.3% Titanium Dioxide, and 0.05% Sorbic acid were then added to the homogenized mixture and heated in the Thermomix to 185° F. for about 5 minutes. The temperature was held at 185° F. for about 4 to about 5 minutes. The mixture was homogenized again at 5000/500 psi. Table 5-1 below shows the whey-based cream cheese product makeup. The whey-based cream cheese product was made to target about 73% moisture, about 0.66% fat, about 10% protein, and about 7.25% lactose. The resulting sample had a texture and consistency comparable to a full fat cream cheese sample having substantially more casein protein than whey protein.

TABLE 5-1
Example 5 Sample Makeup

| Ingredient | % |
|---|---|
| Skim Milk | 40.00 |
| Water | 35.11 |
| WPC-53 | 16.67 |
| Lactic Acid | 0.70 |
| Defoamer | 0.15 |
| Texturizer System | 5.75 |
| Tricalcium Phosphate | 1.27 |
| Titanium Dioxide | 0.30 |
| Sorbic Acid | 0.05 |

TABLE 5-2
Texturizer System Makeup

| Ingredient | % |
|---|---|
| Carob Gum | 7.83 |
| Xanthan Gum | 1.74 |
| Carrageenan Gum | 0.87 |
| Oligofructose | 85.74 |
| Salt | 3.83 |

### EXAMPLE 6

Another variation of the whey-based cream cheese product containing about 12% fat was made in the pilot plant using the same process as example 4, with minor changes to the amounts and ingredients. A different whey protein was used, 7.46 pounds (lbs) of WPC-80 (i.e., whey protein) and 4.64 lbs dehydrated sweet whey were both added into 48.23 lbs of water and 33.05 lbs of cream to make a wet mix batch comprising approximately 100 lbs total, and mixed using a Breddo mixer and heated to 140° F. The mix was then homogenized in a two-stage homogenizer at 5000/500 psi and the resulting cream cheese slurry was then pasteurized at 178° F. for 22 seconds. The mix was then cooled to 72° F. and a culture was added and allowed to ferment for about 15 hours. A dry blend mixture was pre-blended containing 4.0 lbs of C-delight MD 01970 (i.e., maltodextrin), 0.35 lbs of carob gum (i.e., locust bean gum), 0.15 lbs carrageenan gum, and 1.16 lbs salt to form the makeup of the texturizer system as shown in Table 6-2. This makeup utilized a gum blend containing two gums, carob and carrageenan. The fermented mix from day one was broken and the curd was transferred to a mixer. The mix was heated to 180° F. and 5.66% of the dry blend mixture (i.e., texturizer system) and the remaining ingredients of 0.05 lbs of sorbic acid and 0.90 lbs of tricalcium phosphate were added slowly into the mixer, where it was held for 10 minutes. The final mixture was then homogenized in a two-stage homogenizer at 3000 psi/500 psi and packaged by hot-filling into 8 oz. tubs. Table 6-1 below shows the whey-based cream cheese product makeup. The whey-based cream cheese product was made to target about 68.5% moisture, about 12.2% fat, about 7.3% protein, and about 4.6% lactose. The resulting sample had a texture and consistency comparable to a full fat cream cheese sample having substantially more casein protein than whey protein.

TABLE 6-1
Example 6 Sample Makeup

| | |
|---|---|
| Ingredient | % |

Day 1

| | |
|---|---|
| Cream | 33.05 |
| WPC-80 | 7.46 |
| Dehydrated sweet whey | 4.64 |
| Water | 48.23 |
| Culture | 0.006 |
| Total Mix/Curd | 93.39 |

Day 2

| | |
|---|---|
| Curd/Mixture | 93.39 |
| Texturizer System | 5.66 |
| Tricalcium phosphate | 0.90 |
| Sorbic Acid | 0.05 |
| Total | 100 |

TABLE 6-2
Texturizer System Makeup

| Ingredient | % |
|---|---|
| Carob Gum | 6.18 |
| Carrageenan Gum | 2.65 |
| C-Delight MD 01970 | 70.67 |
| Salt | 20.49 |

### EXAMPLE 7

Another variation of the whey-based cream cheese product containing about 18% fat was made in the pilot plant using the same process as example 6, with minor changes to the amounts and ingredients. 6.66 pounds (lbs) of WPC-80 (i.e., whey protein concentrate) and 0.98 lbs dehydrated sweet whey were both added into 38.50 lbs of water and 49.54 lbs of cream to make a wet mix batch comprising approximately 100 lbs total, and mixed using a Breddo mixer and heated to 140° F. The mix was then homogenized in a two-stage homogenizer at 5000/500 psi and the resulting cream cheese slurry was then pasteurized at 178° F. for 22 seconds. The mix was then cooled to 72° F. and a culture was added and allowed to ferment for about 15 hours. A dry blend mixture was pre-blended containing 2.0 lbs of C-delight MD 01970 (i.e., maltodextrin), 0.35 lbs of carob gum (i.e., locust bean gum), and 1.01 lbs salt to form the texturizer system as shown in Table 7-2. This makeup utilized a gum blend containing only one gum, carob gum. The fermented mix from day one was broken and the curd was transferred to a mixer. The mix was heated to 180° F. and 3.36% of the dry blend mixture plus the remaining ingredients, 0.05 lbs of sorbic acid and 0.90 lbs of tricalcium phosphate, were added slowly into the mixer where it was held for 10 minutes. The final mixture was then homogenized in a two-stage homogenizer at 3000 psi/500 psi and packaged by hot-filling into 8 oz. tubs. Table 7-1 below shows the whey-based cream cheese product makeup. The whey-based cream cheese product was made to target about 68% moisture, about 18% fat, about 6.5% protein, and about 2.2% lactose. The resulting sample had a texture and consistency comparable to a full fat cream cheese sample having substantially more casein protein than whey protein.

TABLE 7-1
Example 7 Sample Makeup

| | |
|---|---|
| Ingredient | % |

Day 1

| | |
|---|---|
| Cream | 49.54 |
| WPC-80 | 6.66 |
| Dehydrated sweet whey | 0.98 |
| Water | 38.50 |
| Culture | 0.006 |
| Total Mix/Curd | 95.69 |

Day 2

| | |
|---|---|
| Curd/Mixture | 95.69 |
| Texturizer System | 3.36 |
| Tricalcium Phosphate | 0.90 |
| Sorbic Acid | 0.05 |
| Total | 100 |

TABLE 7-2
Texturizer System Makeup

| Ingredient | % |
|---|---|
| Carob Gum | 10.42 |
| C-Delight MD 01970 | 59.52 |
| Salt | 30.06 |

### EXAMPLE 8

Another variation of the whey-based cream cheese product containing about 9.0% fat was made using a curd-whey culture process. On the first day, 762.4 pounds (lbs) of whole milk and 37.6 lbs of cream are combined and heated to about 140° F. The mixture was homogenized in a two-stage homogenizer at 5000/500 psi and the resulting mixture was then pasteurized at 178° F. for 22 seconds. The mix was then cooled to 72° F. and a culture was added and allowed to ferment for about 15 hours, achieving a pH of about 4.8. After the fermentation process, the curd was separated from the acid whey. The second part of the process, or day 2, combines 2.47 lbs of WPC-80 (i.e., whey protein concentrate), 3.28 lbs WPC-35, 0.05 lbs potassium sorbate, 0.15 lbs lactic acid, 15 lbs water, and about 5 lbs of the texturizer system with about 74.0 lbs of the cream cheese curd obtained after the separation process to make a wet mix batch comprising 100 lbs total, and mixed using a Breddo mixer and heated to 170° F. The texturizer system was made up of 0.38 lbs of Farinex VA-40 (a cross-linked and propylated cook-up potato starch, manufactured by Avebe, in the Netherlands), 0.60 lbs Flogel 60 (i.e., an acid-thinned corn starch obtainable from National Starch and Chemical, in Lincolnshire, Ill.), 2.84 lbs C-Delight 01970, 0.83 lbs salt, 0.40 lbs carrageenan gum. (See Table 8-2 for the texturizer system makeup). The mix was then homogenized in a two-stage homogenizer at 4000/400 psi and the resulting cream cheese slurry was then heated to 190° F. and held for 10 minutes. The final mixture was then cooled to 175° F. and packaged by hot-filling into 8 oz. tubs. Table 8-1 below shows the whey-based cream cheese product makeup. The whey-based cream cheese product was made to target about 73% moisture, about 8.9% fat, about 8% protein, and about 4.3% lactose. The resulting sample had a texture and consistency comparable to a full fat cream cheese sample having substantially more casein protein than whey protein.

TABLE 8-1
Curd-Whey Sample Makeup

| | |
|---|---|
| Ingredient | % |

Day 1

| | |
|---|---|
| Cream | 4.7 |
| Milk | 95.3 |

Day 2

| | |
|---|---|
| Curd/Culture | 74.0 |
| WPC-35 | 3.28 |
| WPC-80 | 2.47 |
| Potassium Sorbate | 0.05 |
| Lactic Acid | 0.15 |
| Texturizer System | 5.05 |
| Water | 15.0 |
| Total | 100 |

TABLE 8-2
Texturizer System Makeup

| Ingredient | % |
|---|---|
| Carrageenan Gum | 7.92 |
| Farinex VA-40 | 7.52 |
| Flojel 60 | 11.88 |
| C-Delight MD 01970 | 56.24 |
| Salt | 16.44 |

Overall, the sample cream cheese products made according to the examples of 1-8 above all result in a texture and consistency that is comparable to a full fat cream cheese sample that has substantially more casein protein than whey protein and that also has a fat content greater than about 25%. Additionally, the cream cheese products that resulted from the methods of preparation of examples 1-5 all had relatively low fat contents (i.e., from about 0.65% to about 1.80%); these samples are therefore considered to be “fat free” cream cheese products. The cream cheese samples that resulted from the methods of examples 6-8 all had a higher fat content (i.e., from about 9% to about 18%) compared to the fat free samples; these samples are considered to be the “light” or “soft” fat cream cheese products. When compared to each other, the fat free and light fat cream cheese products are similar in consistency and texture, however, the fat free version contains a higher amount of protein than the light fat version. This is due to the lower amount of fat content in the fat free version, which allows for a greater amount of protein to be present in place of the fat.

What is claimed is:

1. A whey-based cream cheese food product, the food product comprising:
at least about 60% moisture;
less than 20% fat;
less than 20% protein, wherein at least 50% of the protein is whey protein; and
about 0.4 to about 15% of a carbohydrate-based texturizing composition comprising low dextrose equivalent maltodextrin or oligofructose, at least one gum, and optionally a starch blend;
wherein the food product has a creamy and firm texture comparable to a conventional casein-based cream cheese product having greater than 25% fat.

2. The food product as defined in claim 1, wherein the carbohydrate-based texturizing composition comprises about 37 to about 96% of low dextrose equivalent maltodextrin, about 1 to about 50% of the gum, and about 0.1 to about 19% of the starch blend.

3. The food product as defined in claim 2, wherein the low dextrose equivalent maltodextrin is a potato maltodextrin.

4. The food product as defined in claim 2, wherein the gum contains at least one gum selected from the group consisting of xanthan gum, guar gum, Tara gum, locust bean gum, carrageenan gum, alginate gum, pectin gum, Konjac gum, carboxymethylcellulose gum, methylcellulose gum, and hydroxyl propyl methylcellulose gum.

5. The food product as defined in claim 2, wherein the starch blend comprises a thin boil starch and a modified starch.

6. The food product as defined in claim 2, wherein at least about 80% of the protein is whey protein.

7. The food product as defined in claim 2, wherein the fat is selected from the group consisting of dairy fat, vegetable fat and animal fat.

8. The food product as defined in claim 7, wherein the dairy fat is selected from the group consisting of milk, skim milk, cream, butter, anhydrous milk fat, fatted whey protein concentrate and a combination thereof.

9. The food product as defined in claim 7, wherein the vegetable fat is an oil selected from the group consisting of soybean, palm, kernel, canola, corn, coconut, and a combination thereof.

10. The food product as defined in claim 7, wherein the animal fat is selected from the group consisting of lard, tallow, chicken fat, and a combination thereof.

11. The food product as defined in claim 1, wherein the protein is about 5 to about 20%, the fat is about 1.5 to about 18%, and the moisture is about 60% to about 80%.

12. The food product as defined in claim 2, wherein the gum comprises a gum blend having a first gum and a second gum in a ratio of about 10:90 to about 90:10, where the first gum and the second gum are different and at least one gum is either ionic or nonionic, and selected from either the group of ionic gums consisting of xanthan, carrageenan, alginate, pectin, carboxymethylcellulose, methylcellulose, and hydroxyl propyl methylcellulose, or the group of nonionic gums consisting of guar, Tara, locust bean, and Konjac.

13. The food product as defined in claim 2, further comprising an emulsifier selected from the group consisting of diglycerides, monoglycerides, distilled monoglycerides, lactic acid monoglyceride, glycerol monostearate, and sodium stearoyl lactylates and in amounts from about 0.01 to about 0.5%.

14. The food product as defined in claim 2, wherein the product has a cold viscosity above about 1000 Pascal.

15. The food product as defined in claim 2, wherein a whey protein source is selected from the group consisting of whey protein concentrate, whey protein isolate, sweet whey, acid whey, and a combination thereof.

16. A method for producing a whey-based cream cheese product, the method comprising:
forming a first mixture by combining protein with water and a fat source, wherein at least 50% of the protein is whey protein;
heating the first mixture;
optionally homogenizing the first mixture in a first homogenization step;
blending low dextrose equivalent maltodextrin or oligofructose with at least a gum and optionally a starch blend, salt and an acid to provide a second mixture, and adding about 0.4 to about 15% of the second mixture to the first mixture to form a cream cheese blend and mixing;
heating the cream cheese blend; and
optionally homogenizing the cream cheese blend in a second homogenization step, wherein at least one of the first and second homogenization steps is included.

17. The method of claim 16, wherein if the cream cheese product contains 1% or more fat, at least the first homogenization step is included and if the cream cheese product contains less than 1% fat, at least the second homogenization step is included.

18. A method for producing a whey-based cream cheese product, the method comprising:
forming a first mixture by combining whey protein with water and a fat source, wherein at least 50% of the protein is whey protein;
pasteurizing the first mixture;
optionally homogenizing the first mixture in a first homogenization step;
cooling the first mixture and allowing it to ferment for at least 10 hours and/or adding acid;
blending low dextrose equivalent maltodextrin or oligofructose with at least a gum and optionally a starch blend, salt and/or an acid to provide a second mixture, and adding about 0.4 to about 15% of the second mixture to the first mixture while heating the first mixture to form a cream cheese blend and mixing; and
optionally homogenizing the cream cheese blend in a second homogenization step, wherein at least one of the first and second homogenization steps is included.

19. The method of claim 18, wherein if the cream cheese product contains 1% or more fat, at least the first homogenization step is included and if the cream cheese product contains less than 1% fat, at least the second homogenization step is included.
